(19) United States
(12) Patent Application Publication
(10) Pub. No.: US 2021/0131675 A1
(43) Pub. Date: May 6, 2021

(54) BUILDING SYSTEM

(71) Applicant: Francesco Giovanni Longo, Windsor (CA)

(72) Inventor: Francesco Giovanni Longo, Windsor (CA)

(21) Appl. No.: 17/023,351

(22) Filed: Sep. 16, 2020

Related U.S. Application Data
(63) Continuation of application No. 16/191,384, filed on Nov. 14, 2018, now abandoned.

(51) Int. Cl. F24D 3/14; E04C 2/52; E01C 11/26; F24F 5/00; E01C 11/24

(52) U.S. Cl. CPC F24D 3/141; E04C 2/525; E04H 4/14; F24F 5/0089; E01C 11/245; E01C 11/265

(57) ABSTRACT

A building system comprising of a plurality of panels wherein the building system is configured to be either superposed an existing structure or a ground surface. The plurality of panels of the building system are shaped so as to be mateable when place adjacent to each other. The panels include a bottom and walls that form an interior volume. The bottom and walls of the panels are manufactured from a thermally conductive material such as but not limited to metal. The interior volume of the panels are filled with a lightweight structural material such as but not limited to polyurethane foam or autoclaved concrete. A first temperature source is disposed within the panels and is configured to have a fluid pass therethrough. A second temperature source is present and is a heating element. The panels are operable to utilize either temperature sources.

This application is a continuation of U.S. patent application Ser. No. 16/191,384 filed Nov. 14, 2018, the entirety of which is incorporated herein by reference.

### FIELD OF THE INVENTION

The present invention relates generally to a building system, more specifically but not by way of limitation, a building system that is utilized for structures such as but not limited to driveways and pools that comprises a plurality of panels being comprised of a thermally conductive material and concrete like material that is operable to provide a surface having a temperature that is different than that of its environmental surroundings.

### BACKGROUND

Structures such as but not limited to driveways and pools are common and constructed on a routine basis. As is known in the art, various construction techniques exist for the aforementioned. Driveways are routinely manufactured from paving stoves or concrete while conventional pool building techniques can include but is not limited to concrete, fiberglass and vinyl with a base structure. Regardless of the technique, none of the aforementioned techniques have the ability to provide a temperature that is different than that of its surroundings. Depending upon the environment it is often desirable to control the temperature of a structure. Much like bathrooms can be provide with a heated tile floor, there are advantages to be able to provide a heated or cooled surface that is integral into the structural components.

One disadvantage of conventional construction for structures such as but not limited to driveways and pools is their inability to offer temperature control. By way of example but not limitation, a conventional driveway installed in a climate where snow is common will accumulate the snow and as such as user must employ an implement such as a snow blower to remove the snow from the driveway. It would be desirable if the driveway included an integrated technique to inhibit the accumulation of snow thereon. Another example of a temperature control is in the area of swimming pools. Depending upon the climate, it is desirable to heat the water in the pool so as to provide a more enjoyable experience for users of the pool. Conventional heating methods such as furnaces can be quite expensive to use and as water temperature dissipates quickly are inefficient.

Accordingly, there is a need for a building system that can be utilized to construct various items that is operable to provide a temperature to the surface thereof wherein the surface temperature is different than that of its surroundings.

### SUMMARY OF THE INVENTION

It is the object of the present invention to provide a building system that can be utilized to construct numerous different items such as but not limited to driveways, pools and scaffolding surface wherein the building system comprises a plurality of panels that are configured to be operably coupled.

Another object of the present invention is to provide a building system including a plurality of panels that is configured to provide temperature control of the structure composed of the plurality of panels wherein the panels include a bottom and at least one wall defining an interior volume.

A further object of the present invention is to provide a building system that can be utilized to construct numerous different items such as but not limited to driveways, pools and scaffolding surface wherein the panels are manufactured from a thermally conductive material such as but not limited to metal.

Still another object of the present invention is to provide a building system including a plurality of panels that is configured to provide temperature control of the structure composed of the plurality of panels wherein the interior volume of the panels is filled with a lightweight material such as but not limited to autoclaved concrete or polyurethane foam.

An additional object of the present invention is to provide a building system that can be utilized to construct numerous different items such as but not limited to driveways, pools and scaffolding surface wherein the panels further include a first temperature source disposed in the interior volume.

Yet a further object of the present invention is to provide a building system including a plurality of panels that is configured to provide temperature control of the structure composed of the plurality of panels that further includes a second temperature source disposed in the interior volume of the plurality of panels.

Another object of the present invention is to provide a building system that can be utilized to construct numerous different items such as but not limited to driveways, pools and scaffolding surface wherein the first heating source is a tubing network that is configured to be operably coupled to a water source.

An alternate object of the present invention is to provide a building system including a plurality of panels that is configured to provide temperature control of the structure composed of the plurality of panels wherein the second temperature source is a electric heating element.

Still a further object of the present invention is to provide a building system that can be utilized to construct numerous different items such as but not limited to driveways, pools and scaffolding surface wherein plurality of panels can be overlaid an existing structure or be newly installed.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a view of the interior volume of a panel of the building system of the present invention; and

FIG. 2 is a view of a panel of the building system of the present invention wherein the panel has been filled with a desired material; and

FIG. 3 is an exemplary installation of the building system of the present invention; and

FIG. 4 is an alternate exemplary installation of the building system of the present invention

### DETAILED DESCRIPTION

Referring now to the drawings submitted herewith, wherein various elements depicted therein are not necessarily drawn to scale and wherein through the views and figures like elements are referenced with identical reference numerals, there is illustrated a building system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the building system 100 includes a plurality of panels 10. The panel 10 includes a plurality of walls 12 and a bottom 14 that are integrally formed to create an interior volume 16. The panel 10 is manufactured from a suitable rigid thermally conductive material such as but not limited to metal. It is contemplated within the scope of the present invention that the panel 10 could be manufactured from a metal such as but not limited to stainless steelq or galvanized metal. While the panel 10 is illustrated herein as being rectangular in shape having four walls 12, it is contemplated within the scope of the present invention that the panel 10 could be comprised of less than four walls 12 or more than four walls 12. It is desired within the scope of the present invention that the panel 10 is constructed to mateably secured within a configuration of a plurality of panels 10 in order to achieve the desired objective of creating a surface. It should be understood within the scope of the present invention that the panel 10 could be formed in numerous alternate shapes and sizes so as to be configurable with a plurality of panels 10 wherein each panel 10 is mateably adjacent another panel 10 so as to form a surface such as but not limited to a driveway or lining for an in-ground swimming pool. While the walls 12 are illustrated herein as being perpendicular to the bottom 14, it is contemplated within the scope of the present invention that at least one wall 12 of a panel 10 could be angular in orientation so as to transition to an adjacent existing object such as but not limited to a garage floor or foundation. By way of example but not limitation, a wall 12 could be formed so as to be approximately forty-five degrees with respect to the bottom 14 and form an angle so when panel 10 is positioned the wall 12 having the forty-five degree angle is adjacent the existing structure. It is further contemplated within the scope of the present invention that the panel 10 could be formed with a filler material as further described herein and implemented without the bottom 10 and walls wherein installation of the material would include the formed filler material having the first temperature source 20 and a second temperature source 30 disposed therein.

Disposed within the interior volume 16 of the panel 10 is a first temperature source 20 and a second temperature source 30. The first temperature source 20 and the second temperature source 30 are operable to provide a temperature for the panel 10 that is different than that of the environmental surroundings of the panel 10. By way of example but not limitation, the first temperature source 10 could be configured to provide a temperature of the panel 10 that is either cooler or warmer than the environmental surroundings of the panel 10. While for many applications it will be desirable to provide a temperature of the panel 10 that is warmer than that of environmental temperature surrounding the panel 10, it should be understood within the scope of the present invention that the first temperature source 20 could alter the temperature of the panel 10 in either a negative or positive direction.

The first temperature source 20 is secured within the interior volume 16 utilizing fasteners 22. Fasteners 22 are conventional mechanical fasteners that are operable to secure the first temperature source 20 to the inner surface 13 of the bottom 14. It should be understood within the scope of the present invention that the fastener 22 could be numerous alternate types of fasteners of suitable size and type required to secure the first temperature source 20 to the inner surface 13 of the bottom 14. The first temperature source 20 is comprised of a tube such as but not limited to a nylon tube that is hollow having a passage therethrough. The first temperature source 20 includes a first end 23 and a second end 24. In a preferred embodiment, the first temperature source 20 is configured to be operably coupled to a fluid source (not illustrated herein) wherein the fluid source has water therein that is either warmer or colder than that of the environmental surroundings of the building system 100. By way of example but not limitation, the first temperature source 20 could be operably coupled to a tank having an antifreeze solution disposed therein. The fluid source would include a conventional fluid pump wherein the fluid is distributed through the first temperature source 20 and the thermally conductive material of the panel 10 would assist in the thermal conduction. It is contemplated within the scope of the present invention that the first temperature source 20 could be manufactured in various diameters and from alternate materials. The first temperature source 20 is journaled through apertures 40 that are formed in the walls 12 as required to operably couple each first temperature source 20 disposed within the interior volume 16 of a panel 10 so as to create a network within the plurality of panels 10 installed as depicted herein for exemplary installations.

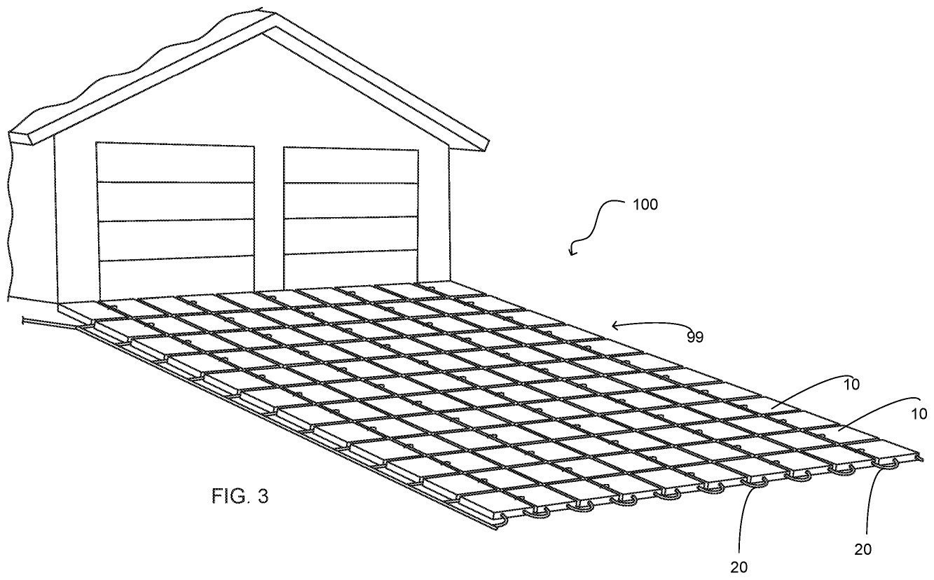

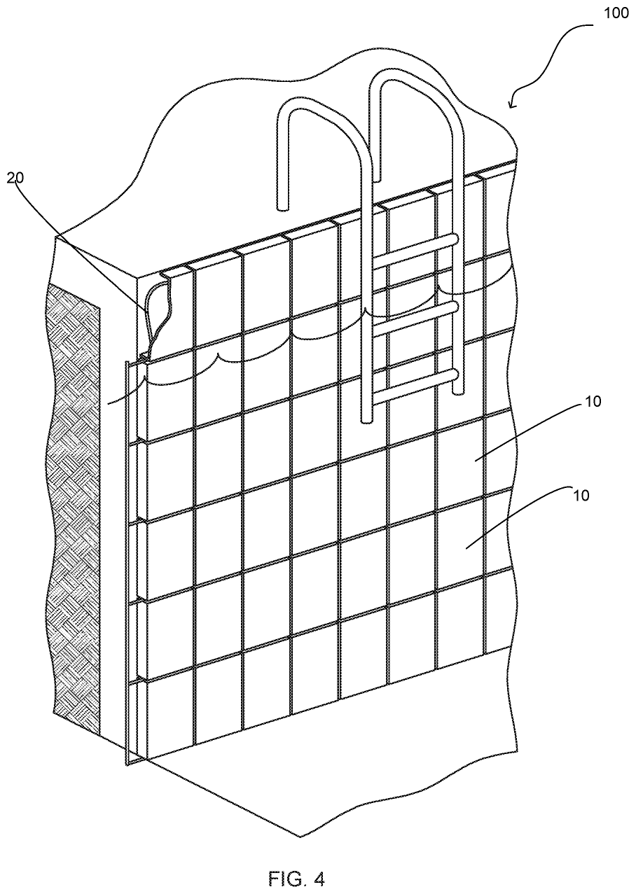

By way of example but not limitation, illustrated herein in FIG. 3 is an exemplary installation of the building system 100 wherein a plurality of panels 10 have been mateably laid in order to create a driveway surface. The bottom 14 of the panel 10 is facing in an upward direction and as such the temperature of the first temperature source 20 is adjacent the surface of the driveway 99. In environments wherein accumulation of snow and ice on a driveway 99 is common, the first temperature source 20 would have a warm fluid being distributed therethrough so as to increase the temperature of the driveway 99 to a temperature that is greater than that of its environmental surroundings so as to inhibit the accumulation of snow and/or ice. It should be understood that the exemplary installations illustrated herein in FIG. 3 and FIG. 4 do not reflect the cosmetic outer appearance of the final installation of the building system 100 and that a consistent cosmetic layer of a suitable durable material would be superposed the plurality of panels 10. It should be further understood within the scope of the present invention that the panels 10 could be mechanically secured to each other utilizing numerous styles of clips or similar type fasteners that would be suitable for the desired installation. The aforementioned clips/fasteners would function to secure adjacent walls 12 of each of the plurality of panels that have been utilized in an installation of the building system 100.

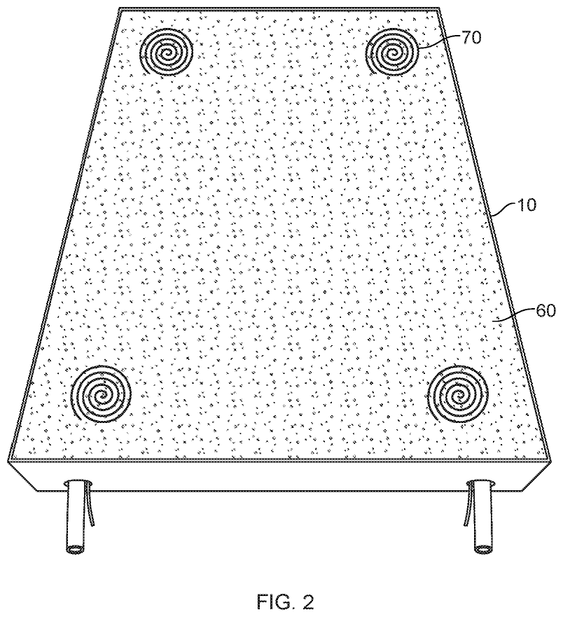

Referring in particular to FIG. 2, the panel 10 is filled with a material such as but not limited to polyurethane foam or autoclaved concrete. An advantage of the building system 100 of the present invention is the reduced weight when compared to alternative construction techniques. Utilizing a material such as but not limited polyurethane foam or autoclaved concrete provides structural rigidity without unnecessary weight. It is contemplated within the scope of the present invention that the interior volume 16 of the panel 10 could be filled with various alternate suitable material operable to provide the desired functionality as described herein.

The panels 10 further include anchor members 70. Anchor members 70 are provided if required to secure the panel 10 to a surface on which the panel 10 is being superposed. The panels 10 can be superposed an existing structure such as but not limited to a driveway constructed of conventional materials or be installed on the ground. It is contemplated within the scope of the present invention that the anchor members 70 could have alternate configurations so as to be suitable for use depending on the substance on which the panels 10 are being superposed or placed adjacent thereto. It is further contemplated within the scope of the present invention that the anchor members 70 are constructed so as to provide the ability to accommodate movement of the panel 10 and or surface on which the panel 10 is installed. By way of example but not limitation, if the panels 10 are installed on the ground in a climate having significant temperature changes that cause the ground to move, the anchor members 70 are constructed to accommodate such movement and preserve the structural integrity of the building system 100.

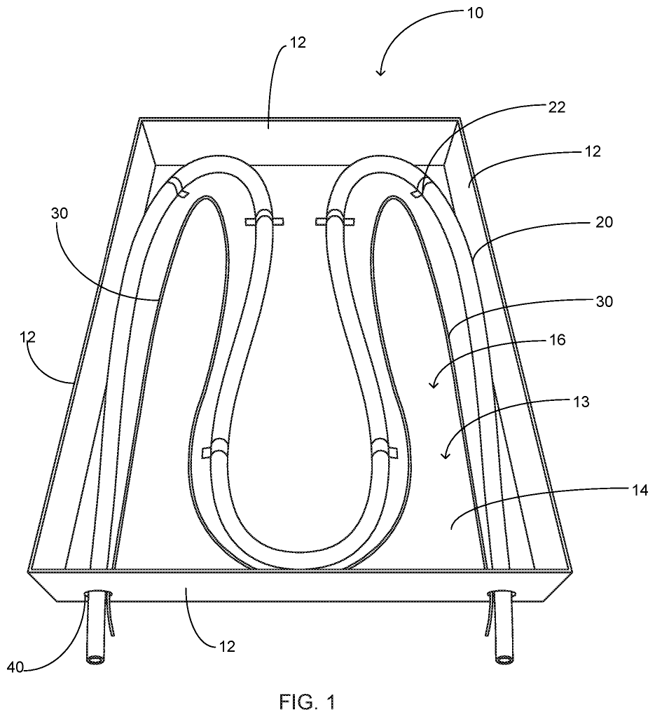

Referring again to FIG. 1, the panel 10 has disposed therein a second temperature source 30. The second temperature source 30 functions similarly to the first temperature source 20 and is operable to provide a temperature to the panel 10 that is warmer than that of the environmental surroundings of the building system 100. The second temperature source 30 is a heating element such as but not limited to an electrical heating element and is operably coupled to a required power source/controller (not illustrated herein). The second temperature source 30 is provided so as to deliver a second technique of increasing the temperature of the building system 100 as required. Those skilled in the art will recognize that the heating element of the second temperature source 30 could be rated for various alternate currents and or amperages in order to achieve the desired objective discussed herein.

It should be understood within the scope of the present invention that the building system 100 could be operable in a first mode wherein the second temperature source 30 is utilized to heat the panels 10 and in a second mode the first temperature source 20 is utilized to either heat or cool the panels 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A building system comprising:
a plurality of panels, said plurality of panels having a first side and a second side;
a first temperature source, said first temperature source being disposed within said interior volume of said plurality of panels, said first temperature source having a first end and a second end, said first temperature source being a tube having a hollow passage, said first temperature source configured to have a fluid flow therethrough; and
wherein the plurality of panels are utilized to construct an object so as to provide a temperature of the object that is different than that of environmental surroundings of the object.

2. The building system as recited in claim 1, and further including a second temperature source, said second temperature source being disposed within the interior volume of the plurality of panels, said second temperature source operable to increase the temperature of the plurality of panels.

3. The building system as recited in claim 2, wherein the first temperature source is operably coupled to a fluid tank.

4. The building system as recited in claim 3, wherein the interior volume of the plurality of panels is filled with at least one of the following: polyurethane foam or autoclaved concrete.

5. The building system as recited in claim 4, that further includes at least two apertures, said at least two apertures providing access for said first temperature source and said second temperature source into said plurality of panels.

6. The building system as recited in claim 5, and further including at least one anchor member, said at least one anchor member operable to assist in installation of said plurality of panels, said at least one anchor member coupled to said plurality of panels opposite said bottom.

7. The building system as recited in claim 6, wherein each of said plurality of panels are shaped so as to be mateable ensuing being placed adjacent to each other.

8. A building system that is operable to provide a temperature to the surface thereof that is different than that of its environmental surroundings:
a plurality of panels, said plurality of panels having a bottom and a plurality of walls forming an interior volume, said plurality of panels having a first side and a second side, said plurality of panels having an opening on said first said opposite said bottom providing access to the interior volume, said plurality of panels being formed so as to be mateable when placed adjacent to each other, said plurality of walls and said bottom being manufactured from metal;
a first temperature source, said first temperature source being disposed within said interior volume of said plurality of panels, said first temperature source having a first end and a second end, said first temperature source being a tube having a hollow passage, said first temperature source being operably coupled to a fluid source, said first temperature source configured to have a fluid flow therethrough;
a second temperature source, said second temperature source being disposed within the interior volume of the plurality of panels, said second temperature source operable to increase the temperature of the plurality of panels; and
wherein the building system is configured to operate in a first mode and a second mode, wherein in the second mode of the building system the first temperature source is utilized to either increase or decrease the temperature of the plurality of panels.

9. The building system as recited in claim 8, wherein in the second mode of the building system the second temperature source is operable to increase the temperature of the plurality of panels.

10. The building system as recited in claim 9, wherein at least one of the walls of one of said plurality of panels is oriented at an angle with respect to said bottom at an angle of forty-five degrees.

11. The building system as recited in claim 10, wherein at least one of the plurality of walls includes two apertures, said two apertures providing access for said first temperature source and said second temperature source into said interior volume.

12. The building system as recited in claim 11, wherein the interior volume of the plurality of panels is filled with at least one of the following: polyurethane foam or autoclaved concrete.

13. The building system as recited in claim 12, and further including at least one anchor member, said at least one anchor member operable to assist in installation of said plurality of panels, said at least one anchor member coupled to said plurality of panels opposite said bottom.

14. The building system as recited in claim 13, and further including a plurality of fasteners, said plurality of fasteners disposed within said interior volume of said plurality of panels, said plurality of fasteners configured to secure said first temperature source and said second temperature source.

15. A building system that is operable to provide a temperature to the surface thereof that is different than that of its environmental surroundings:
a plurality of panels, said plurality of panels having a bottom and four walls forming an interior volume, said four walls being perpendicular to said bottom, said plurality of panels having a first side and a second side, said plurality of panels having an opening on said first said opposite said bottom providing access to the interior volume, said plurality of panels being formed so as to be mateable when placed adjacent to each other, said plurality of walls and said bottom being manufactured from metal, said plurality of panels having a lightweight material disposed in said interior volume thereof;
a first temperature source, said first temperature source being disposed within said interior volume of said plurality of panels, said first temperature source having a first end and a second end, said first temperature source being a tube having a hollow passage, said first temperature source being operably coupled to a fluid source, said first temperature source configured to have a fluid flow therethrough;
a second temperature source, said second temperature source being disposed within the interior volume of the plurality of panels, said second temperature source operable to increase the temperature of the plurality of panels;
at least one anchor member, said at least one anchor member operable to assist in installation of said plurality of panels, said at least one anchor member coupled to said plurality of panels opposite said bottom; and
wherein the building system is configured to operate in a first mode and a second mode, wherein in the second mode of the building system the first temperature source is utilized to either increase or decrease the temperature of the plurality of panels and in said first mode the second temperature source is operable to increase the temperature of the plurality of panels.

16. The building system as recited in claim 15, wherein the interior volume of the plurality of panels is filled with at least one of the following: polyurethane foam or autoclaved concrete.

17. The building system as recited in claim 16, wherein at least one of the four walls includes two apertures, said two apertures providing access for said first temperature source and said second temperature source into said interior volume.

18. The building system as recited in claim 17, wherein one of said four walls of one of said plurality of panels is oriented at an angle with respect to said bottom at an angle of forty-five degrees.

19. The building system as recited in claim 18, and further including a plurality of fasteners, said plurality of fasteners disposed within said interior volume of said plurality of panels, said plurality of fasteners configured to secure said first temperature source and said second temperature source.

20. The building system as recited in claim 19, wherein the building system is configured to be superposed an existing structure or a ground surface.
